(19) United States
(12) Patent Application Publication
(10) Pub. No.: US 2026/0049671 A1
(43) Pub. Date: Feb. 19, 2026

(54) VALVE, CONTROL METHOD THEREOF, AND VALVE SYSTEM

(71) Applicant: HIGHLIGHT TECH CORP., Tainan City (TW)

(72) Inventors: CHWUNG-SHAN KOU, Tainan City (TW); WEN-YUNG YEH, Tainan City (TW); Hsuan-Yu Lin, Tainan City (TW); SZU-MIN LIN, Tainan City (TW); MU-TENG TSAI, Tainan City (TW); HUNG-CHIH YEH, Tainan City (TW)

(73) Assignee: HIGHLIGHT TECH CORP., Tainan City (TW)

(21) Appl. No.: 19/298,410

(22) Filed: Aug. 13, 2025

Related U.S. Application Data
(60) Provisional application No. 63/684,347, filed on Aug. 17, 2024.

(30) Foreign Application Priority Data
Aug. 4, 2025 (TW) 114129636

(51) Int. Cl. F16K 31/42; G05D 7/06

(52) U.S. Cl. CPC F16K 31/42; G05D 7/0629

(57) ABSTRACT

Disclosed are a valve, a control method thereof, and a valve system. The valve is provided with a valve body and a valve disc, wherein the valve disc is driven by a pneumatic unit of the valve system to perform an operation within a chamber of the valve body. A gas is supplied to the pneumatic unit, such that the pneumatic unit controls the operation of the valve disc in a pneumatic manner according to gas parameter of the gas. Furthermore, the gas parameter provided to the pneumatic unit is adjusted to smooth the operation of the valve disc. The valve is optionally further provided with an actuation correction structure for preventing the valve disc from getting stuck.

### CROSS-REFERENCE TO RELATED APPLICATION

This application claims priority to U.S. Provisional Patent Application No. 63/684,347, filed on Aug. 17, 2024; claims priority from Taiwan Patent Application No. 114129636, filed on Aug. 4, 2025, each of which is hereby incorporated herein by reference in their entireties.

### BACKGROUND OF THE DISCLOSURE

### 1. Field of Disclosure

The disclosure relates to a valve and a valve system thereof, and more particularly to a valve and a control method and valve system thereof that improve performance through special control methods and structures.

### 2. Related Art

In semiconductor manufacturing processes, vacuum coating, or other industrial applications requiring high cleanliness, pneumatic valves are key components for controlling gas flow or isolating vacuum chambers. To pursue higher production efficiency, such valves usually need to have the ability to open and close quickly. However, when traditional pneumatic valves operate at high speed, their valve discs violently impact the valve body, generating significant vibration, and this vibration can also occur during the operation process itself. This vibration may also occur during the operation, and not only transmits to the entire equipment, affecting the operation of other precision components, but also may stir up attached dust particles inside the valve or in the vacuum chamber, causing product contamination and a decrease in yield.

Furthermore, when a valve is operated in a vacuum environment, a local vacuum state may form between the valve disc and the inner surface of the valve body when the valve disc is in an open state, leading to valve disc sticking or movement delay, which affects the timing control of the process. On the other hand, to drive the valve disc to move at high speed, the pneumatic unit needs to provide strong thrust. At the end of the stroke, even if the air pressure has been removed, the valve disc will continue to move due to inertia, possibly hitting the mechanical stop at the end of the stroke, or even exceeding the predetermined stroke range. This kind of overtravel phenomenon also causes impact, wear, or vibration, and affects the positioning accuracy of the valve.

Existing solutions usually focus only on a single problem, such as setting a simple mechanical buffer to absorb impact, or using a simple throttle valve to roughly control airflow. However, these methods are difficult to simultaneously balance the requirements of high-speed operation, low vibration, and high reliability, and could not meet the increasingly stringent demands of advanced processes.

### SUMMARY OF THE DISCLOSURE

The disclosure provides a control method for a valve, comprising the following steps: providing a valve, the valve comprising a valve body and a valve disc, the valve body having a chamber, the valve disc being movably disposed in the chamber of the valve body and driven by a pneumatic unit to perform an operation; and performing a pneumatic regulation procedure, the pneumatic regulation procedure adjusting a gas parameter supplied to the pneumatic unit in an adjustment mode when the valve disc performs the operation, so that the pneumatic unit pneumatically controls the operation of the valve disc accordingly, thereby regulating a vibration value generated by the valve when the valve disc performs the operation.

The disclosure provides a valve system, comprising: a valve, the valve comprising a valve body and a valve disc, the valve body having a chamber, the valve disc being movably disposed in the chamber of the valve body; a pneumatic unit configured to drive the valve disc of the valve to perform an operation; and a control element, the control element adjusting a gas parameter supplied to the pneumatic unit in an adjustment mode according to a pneumatic regulation procedure, so that the pneumatic unit pneumatically controls the operation of the valve disc accordingly, thereby regulating a vibration value generated by the valve when the valve disc performs the operation.

The disclosure provides a valve, comprising: a valve body, the valve body having a chamber; a valve disc, the valve disc being movably disposed in the chamber of the valve body and driven by a pneumatic unit to perform an operation, wherein the pneumatic unit pneumatically controls the operation of the valve disc accordingly based on a gas parameter supplied to the pneumatic unit; and an actuation correction structure configured to prevent the valve disc from incorrectly staying at a position in the valve body when the valve disc performs the operation.

In order to enable the examiner to have a further understanding and recognition of the technical features of the disclosure, preferred embodiments in conjunction with detailed explanation are provided as follows.

### BRIEF DESCRIPTION OF THE DRAWINGS

FIG. 1 is a schematic flow diagram illustrating a control method for a valve according to the disclosure.

FIG. 2 is a schematic functional block diagram illustrating a valve system according to the disclosure.

FIG. 3 is a schematic partial structural diagram illustrating a first embodiment of a valve according to the disclosure, showing the valve in a closed state.

FIG. 4 is a schematic partial structural diagram illustrating a second embodiment of a valve according to the disclosure, showing the valve in a closed state.

FIG. 5 is a schematic side view taken along section line D-D in FIG. 4.

FIG. 6 is an enlarged view of local area E in FIG. 5.

FIG. 7 is a schematic partial structural diagram illustrating a second embodiment of a valve according to the disclosure, showing the valve in an open state, and the actuation correction structure of the valve having a vacuum breaking structure and a reset structure.

FIG. 8 is a schematic partial structural diagram illustrating a second embodiment of a valve according to the disclosure, showing the valve in an open state, and the valve hitting the reset structure due to exceeding a predetermined stroke range, wherein the actuation correction structure of the valve has a reset structure.

FIG. 9 is a schematic structural diagram of the valve shown in FIG. 8, showing the valve in an open state, and the reset structure resetting the valve to within the predetermined stroke range.

FIG. 10 is a schematic partial structural diagram illustrating a second embodiment of a valve according to the disclosure, showing the valve in a closed state, wherein the actuation correction structure of the valve has a vacuum breaking structure.

### DETAILED DESCRIPTION OF THE DISCLOSURE

In order to understand the technical features, content and advantages of the disclosure and its achievable efficacies, the disclosure is described below in detail in conjunction with the figures, and in the form of embodiments, the figures used herein are only for a purpose of schematically supplementing the specification, and may not be true proportions and precise configurations after implementation of the disclosure; and therefore, relationship between the proportions and configurations of the attached figures should not be interpreted to limit the scope of the claims of the disclosure in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present disclosure will be defined below or in other parts of the descriptions as an extra guidance for those skilled in the art to understand the descriptions of the present disclosure.

The terms such as “first”, “second”, “third” and “fourth” used in the descriptions do not indicate an order or sequence, and are not intended to limit the scope of the present disclosure. They are used only for differentiation of components or operations described by the same terms.

Moreover, the terms “comprising”, “including”, “having”, and “with” used in the descriptions are all open terms and have the meaning of “comprising but not limited to”.

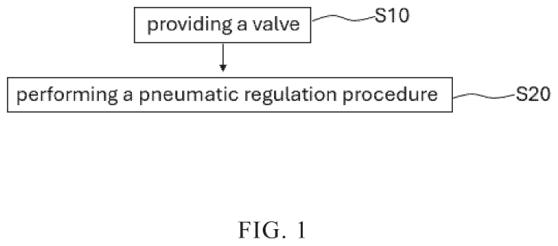

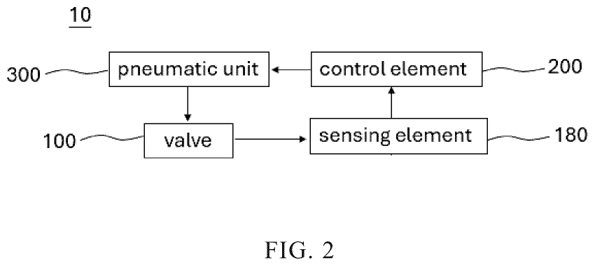

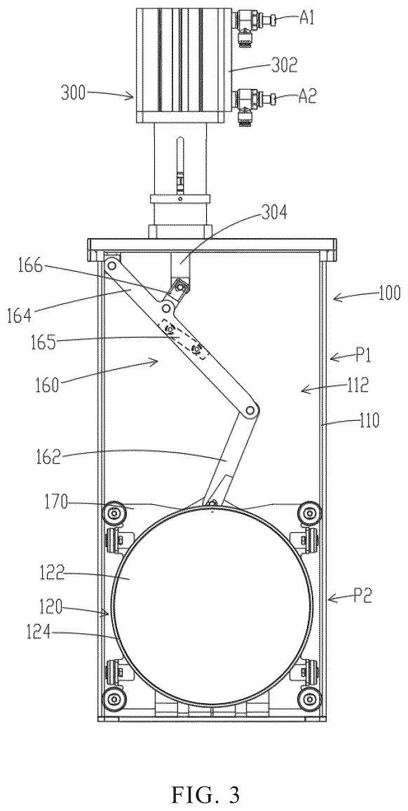

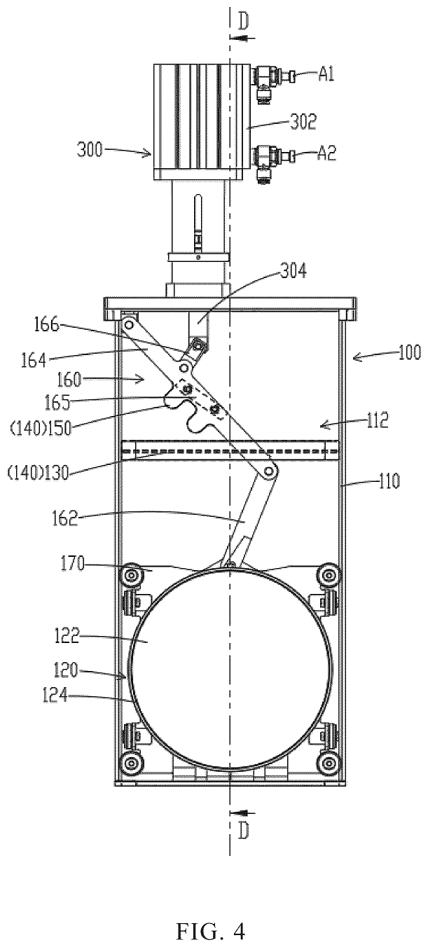

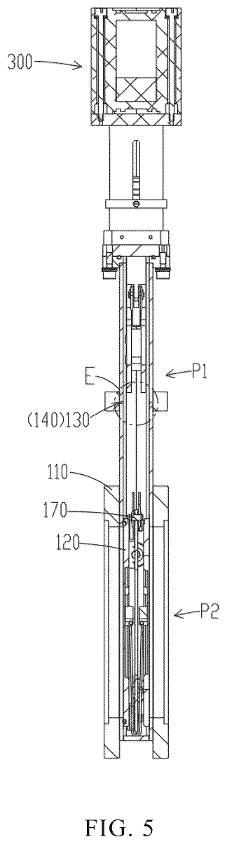

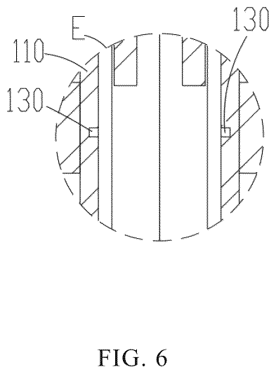

Please refer to FIGS. 1 to 3, and also to FIGS. 4 to 10 simultaneously. FIG. 1 is a schematic flow diagram illustrating a control method for a valve according to the disclosure. FIG. 2 is a schematic functional block diagram illustrating a valve system according to the disclosure. FIG. 3 is a schematic structural diagram illustrating a first embodiment of a valve according to the disclosure. The control method for a valve according to the disclosure mainly includes two steps: providing a valve 100 (step S10) and performing a pneumatic regulation procedure (step S20). The valve 100 of the disclosure mainly includes a valve body 110 and a valve disc 120. The valve body 110 has a chamber 112. The valve disc 120 is movably disposed in the chamber 112 of the valve body 110 and is driven by a pneumatic unit 300 to perform an operation (e.g., opening/closing actuation or other actuation) relative to the valve body 110. Optionally, the valve 100 further includes a linkage structure 160. The valve disc 120 is, for example, connected to the pneumatic unit 300 via the linkage structure 160, thereby being driven by the pneumatic unit 300 to operate. The operation of the valve disc 120 is, for example, reciprocating displacement between an open position (e.g., fully open position P1) and a closed position (e.g., fully closed position P2), or moving to any predetermined position between the fully open position P1 and the fully closed position P2. The linkage structure 160 is, for example, a toggle linkage structure including a first link 162, a second link 164, and a rocker arm 166. For example, when the pneumatic unit 300 drives the toggle linkage structure from a contracted state to an expanded state, the valve disc 120 could be moved from the fully open position P1 to the fully closed position P2 (i.e., the position corresponding to the opening on the valve body 110), thereby closing the valve 100. When the pneumatic unit 300 drives the toggle linkage structure from an expanded state to a contracted state, the valve disc 120 could be moved from the fully closed position P2 to the fully open position P1 (i.e., the position not corresponding to the opening on the valve body 110), thereby opening the valve 100. A baffle 165 could be optionally provided on a rod body (e.g., the second link 164) of the toggle linkage structure. The baffle 165 could be used to limit another rod body (e.g., the first link 162) when the toggle linkage structure changes from an expanded state to a contracted state, to prevent the rod bodies from sticking or the valve disc 120 from sticking due to exceeding a predetermined stroke range.

For example, the pneumatic unit 300 is, for example, an air cylinder. The air cylinder is, for example, disposed on the valve 100, and the pneumatic unit 300 is controlled by a control element 200, thereby driving the valve disc 120 of the valve 100 to operate. The valve system 10 of the disclosure mainly includes the valve 100, the pneumatic unit 300, and the control element 200. The valve system 10 of the disclosure may also optionally include a sensing element 180. The air cylinder mainly includes a cylinder body 302, a piston, and a piston rod 304. The cylinder body 302 is disposed on the valve body 110 of the valve 100. The piston is located inside the cylinder body 302 and is movable. One end of the piston rod 304 is connected to the piston. The other end of the piston rod 304 protrudes outside the cylinder body 302 and is connected to the valve disc 120 of the valve 100 via the linkage structure 160 of the valve 100. The air cylinder further has two gas input/output ports A1 and A2 located on the cylinder body 302 and on both sides of the piston. The disclosure could, for example, adjust the gas pressure and/or gas flow supplied to the cylinder body 302 through the two gas input/output ports A1 and A2, so that a pressure difference is generated on both sides of the piston, thereby driving the displacement of the piston rod 304, thereby driving the valve disc 120 of the valve 100 to operate. For example, the thrust value of the valve disc 120 corresponds to the value of the gas pressure, and the speed value of the valve disc 120 corresponds to the value of the gas flow. The gas described above is, for example, supplied by a gas source (not shown). In addition, since those skilled in the art to which the disclosure belongs should understand how to supply gas to the cylinder body to generate a pressure difference on both sides of the piston of the air cylinder, thereby driving the valve disc 120 to perform corresponding operations, such as opening/closing actuation or other actuation, no further details are provided here.

A feature of the disclosure is that when the valve disc 120 of the valve 100 is operating (e.g., during opening actuation, closing actuation, or other actuation), a pneumatic regulation procedure (step S20) is performed to adjust a gas parameter supplied to the pneumatic unit 300, so that the pneumatic unit 300 could pneumatically control the operation of the valve disc 120 accordingly, thereby regulating a vibration value generated by the valve 100 when the valve disc 120 operates. The aforementioned vibration value is an indicator for measuring the degree of shaking of the valve 100 during operation, and the vibration value is positively correlated with the amount of dust raised by the vibration. The aforementioned gas parameter is, for example, a gas pressure and/or a gas flow of at least one gas. The aforementioned gas could be, for example, air or other gases. Furthermore, any gas parameter of the aforementioned gas that could be used by the pneumatic unit 300 to regulate the operation of the valve disc 120 falls within the scope of protection claimed by the disclosure. Taking the reduction of vibration value and dust amount as an example, the adjustment mode of the pneumatic regulation procedure is, for example, to adjust the gas parameter supplied to the pneumatic unit 300, so that the operation of the valve disc 120 becomes a smooth actuation (or smooth movement), thereby reducing the vibration value generated by the valve 100 when the valve disc 120 operates, wherein the smooth actuation is a smooth closing actuation, a smooth opening actuation, or a smooth moving actuation.

The disclosure utilizes a pneumatic regulation procedure (step S20) to adjust the gas parameters (such as gas pressure and/or gas flow) supplied to the pneumatic unit 300, thereby regulating (adjusting and controlling) the movement parameters (such as the movement speed, acceleration, deceleration, or angular velocity of the valve disc 120) of the valve disc 120 during operation. This achieves the effect of regulating (adjusting and controlling) the vibration value of the valve 100 (e.g., reducing the vibration value), and further achieves the effect of regulating the amount of dust raised by the vibration of the valve 100 (e.g., reducing the amount of dust raised). For example, the disclosure could make the operation of the valve disc 120 a smooth actuation by performing the pneumatic regulation procedure (step S20). In addition, the disclosure is not limited to performing this pneumatic regulation procedure during all or part of the operation of the valve disc 120 of the valve 100, as long as it could achieve the effect of regulating the vibration value and the amount of dust raised, it falls within the scope of protection claimed by the disclosure. For example, in a feasible embodiment, when the valve disc 120 of the valve 100 is operating (e.g., closing actuation), the disclosure could also optionally make the movement speed of the valve disc 120 slower as it gets closer to the destination (e.g., fully closed position P2) or the starting point (e.g., fully open position P1). That is, the movement speed of the valve disc 120 is proportional to its distance from the destination (e.g., fully closed position P2) or the starting point (e.g., fully open position P1).

For example, when performing smooth closing actuation, the disclosure could, for example, adjust the gas parameters such as the gas pressure and/or gas flow supplied to the pneumatic unit 300, so that the valve disc 120 could reduce its speed in stages, progressively, or continuously when approaching the fully closed position P2 of the valve body 110, instead of violently impacting or shaking. Thereby, the valve disc 120 could smoothly (or gently) close the opening of the valve body 110. Specifically, the disclosure could slow down the acceleration and deceleration of the valve disc 120 in areas of the valve body 110 where vibration or dust is more likely to occur (e.g., near the ends of the stroke at the fully open position P1 and the fully closed position P2) through the aforementioned pneumatic regulation procedure, making its operation more gentle and smooth (i.e., smooth actuation), thereby reducing the vibration value or dust amount generated by the valve 100 when the valve disc 120 operates. Conversely, the disclosure could also optionally increase the acceleration and deceleration rates in areas of the valve body 110 where vibration is less likely to occur (e.g., the middle section of the opening or closing stroke) to shorten the overall operation time. Through this intelligent speed regulation, the disclosure could not only effectively reduce vibration and dust, but also take into account operational efficiency.

The disclosure uses, for example, a control element 200 to adjust the gas parameters supplied to the pneumatic unit 300 to perform the pneumatic regulation procedure. In addition, the pneumatic regulation procedure of the disclosure could also, for example, use the control element 200 in conjunction with components such as a solenoid valve, a piezoelectric pressure regulating valve, or a voice coil pressure regulating valve, thereby adjusting the gas parameters supplied to the pneumatic unit 300 and enabling the pneumatic unit 300 to pneumatically control the operation of the valve disc 120 accordingly. The control element 200 is, for example, a programmable logic controller (PLC) or an industrial computer or other control or processing device. However, any element that could be used by the pneumatic regulation procedure of the disclosure to adjust the gas parameters of the pneumatic unit 300 could be applied in the disclosure.

For example, to achieve more intelligent control, the pneumatic regulation procedure of the disclosure may optionally further include a machine learning model established by training using an artificial intelligence algorithm (e.g., a neural network algorithm) to define a corresponding relationship among an adjustment value of a gas parameter, at least one valve characteristic value, and a valve actuation vibration value. The aforementioned valve characteristic value is, for example, selected from a group consisting of valve disc weight, valve disc stroke, cylinder bore diameter, air path structure, and operating pressure. In actual operation, the pneumatic regulation procedure of the disclosure could determine the optimal adjustment mode of the gas parameter supplied to the pneumatic unit 300 based on the aforementioned corresponding relationship. In addition, based on the aforementioned machine learning model, the pneumatic regulation procedure of the disclosure could be fully automatic or partially automatic in adjusting the gas parameter supplied to the pneumatic unit 300. For example, after replacing valve discs of different weights, the disclosure could optionally automatically adjust the gas parameters (e.g., gas pressure and/or gas flow supplied to the pneumatic unit 300) to maintain optimal low vibration performance or low dust performance.

The adjustment mode of the pneumatic regulation procedure of the disclosure is, for example, a staged, progressive, or continuous adjustment of the gas parameters supplied to the pneumatic unit 300, for example, adjusting the gas parameters in at least two stages or more, so that the gas parameters (such as gas pressure and/or gas flow) could be set to at least two or more different values in a single operation stroke, thereby achieving smooth actuation. For example, taking the valve disc 120 moving between the fully open position P1 and the fully closed position P2 as an example, when the valve disc 120 starts to move, a higher gas pressure and/or gas flow could be provided to overcome static friction. In the middle of the operation stroke, the gas pressure and/or gas flow could be reduced to stabilize the speed. When approaching the end of the operation stroke, the gas pressure and/or gas flow could be further reduced or even reverse pressure could be provided to achieve buffering and smooth stopping effects.

The control architecture of the valve control method of the disclosure could adopt an open-loop control method or a closed-loop control method. For example, in open-loop control, the pneumatic regulation procedure adjusts the gas parameters such as gas pressure and/or gas flow supplied to the pneumatic unit 300 according to an adjustment mode. In closed-loop control, the pneumatic regulation procedure adjusts the gas parameters such as gas pressure and/or gas flow supplied to the pneumatic unit 300 according to at least one physical state of the valve 100. For example, the control method for the valve 100 of the disclosure further optionally includes using at least one sensing element 180 to sense at least one physical state of the valve 100, so that the pneumatic regulation procedure could adjust the gas parameters such as gas pressure and/or gas flow supplied to the pneumatic unit 300 in an adjustment mode in real-time according to the physical state of the valve 100. Among them, the pneumatic regulation procedure of the disclosure preferably adjusts the gas parameters supplied to the pneumatic unit 300 in real-time (or synchronously) according to the physical state of the valve 100, thereby dynamically adjusting the gas pressure and/or gas flow to achieve better regulation effects. The sensing element 180 is selected from at least one or at least two of a group consisting of a pressure sensor, a force sensor, a temperature sensor, an optical sensor, an image sensor, a vibration sensor, an inertial sensor, and a current sensor.

The control method for the valve of the disclosure is also applicable to metal-to-metal sealed valves, where the valve 100 or its sealing surface could be made of metal material. That is, the valve 100 of the disclosure could optionally omit the rubber O-ring 124 and use metal material as the sealing surface instead. Since metal-to-metal sealed valves are more sensitive to impact vibration and are prone to generating dust, the disclosure could bring more significant improvement effects by making the valve disc 120 operate smoothly.

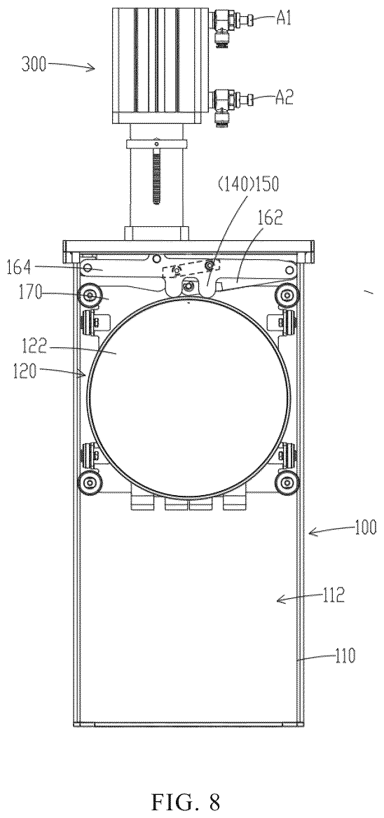

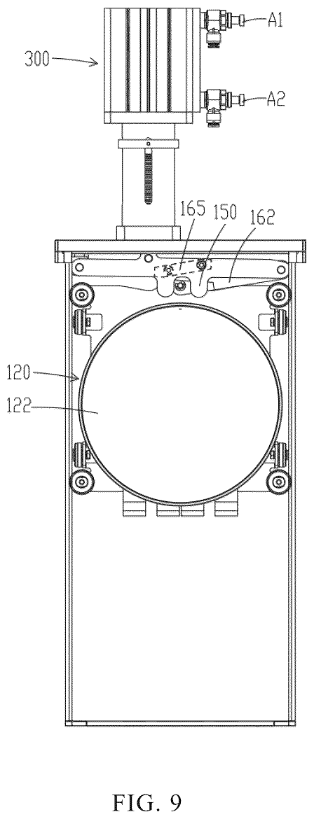

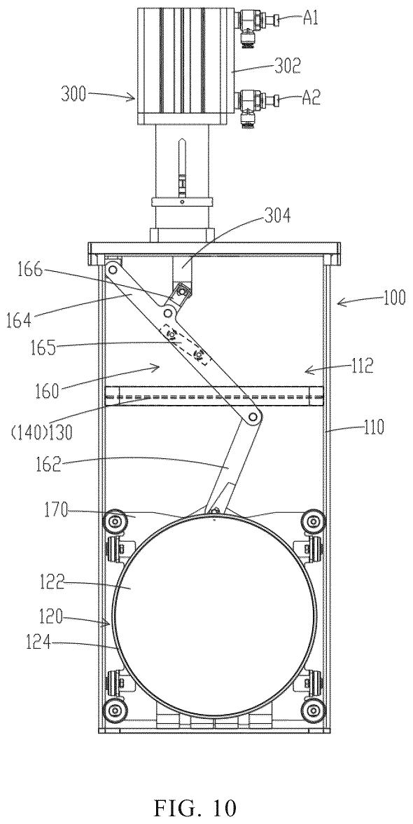

As shown in FIGS. 4 to 9, in addition to the valve body 110 and the valve disc 120, the valve 100 of the disclosure further includes an actuation correction structure 140, for preventing the valve disc 120 from incorrectly sticking at a position in the valve body 110 due to abnormal physical effects when the valve disc 120 is operating, wherein this position is, for example, an expected position or an unexpected position. The aforementioned expected position is, for example, an open position (e.g., fully open position P1), a closed position (e.g., fully closed position P2), or any predetermined position. The aforementioned unexpected position is any position other than the aforementioned expected positions (e.g., an overtravel position). The actuation correction structure 140 of the disclosure is, for example, one or both of a vacuum breaking structure 130 and a reset structure 150. FIGS. 4 to 7 show that the actuation correction structure 140 includes a vacuum breaking structure 130 and a reset structure 150. FIGS. 8 to 9 show that the actuation correction structure 140 only includes a reset structure 150. FIG. 10 shows that the actuation correction structure 140 of the disclosure only includes a vacuum breaking structure 130.

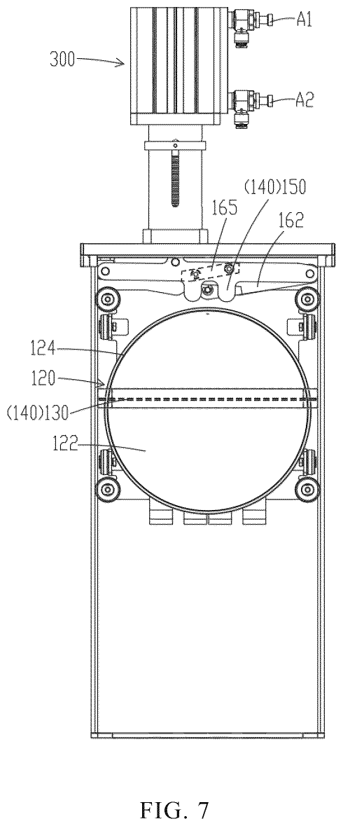

Taking the actuation correction structure 140 including the vacuum breaking structure 130 as an example, the vacuum breaking structure 130 is disposed on the valve body 110, and its main function is to solve the sticking or adsorption phenomenon that may occur due to the formation of a vacuum environment after the valve disc 120 stays at the open position P1 for a long time, ensuring that the operation of the valve disc 120 (e.g., closing actuation) could start smoothly. For example, the vacuum breaking structure 130 is, for example, a groove. The vacuum breaking structure 130 could also be, for example, any structure that could prevent the occurrence of vacuum adsorption between the valve disc 120 and the valve body 110. Taking the groove as an example, this groove is disposed on an inner surface of the valve body 110. As shown in FIG. 7, when the valve disc 120 is operating (e.g., moving from the fully open position P1 to the fully closed position P2, moving from the fully closed position P2 to the fully open position P1, or moving to any predetermined position between the fully open position P1 and the fully closed position P2), there will be a period of time during which an area of the valve body 110 covered by the valve disc 120 and another area of the valve body 110 not covered by the valve disc 120 could communicate with each other through the aforementioned groove, thereby balancing the internal and external pressures and achieving the effect of breaking the vacuum. The aforementioned period of time is, for example, when the valve disc 120 is in an opening actuation period, a closing actuation period, or a moving actuation period.

To solve the adsorption problem in the open state, the vacuum breaking structure 130 (e.g., a groove) is strategically placed on the inner surface of the valve body 110, its position corresponding to the fully open position P1 of the valve disc 120. As shown in FIG. 7, when the valve disc 120 of the valve 100 is in the fully open position P1, the valve disc 120 could avoid vacuum adsorption with the valve body 110 by partially overlapping the vacuum breaking structure 130 (e.g., a groove). In other words, if the valve disc 120 includes a plate body 122 and an O-ring 124, then when the valve disc 120 is in the fully open position P1, the O-ring 124 will partially overlap the vacuum breaking structure 130 (e.g., a groove). At this time, external gas could flow into the space between the valve disc 120 and the inner surface of the valve body 110 along the groove, thereby balancing the pressure difference around the valve disc 120 and breaking any possible vacuum adsorption effect, so that the valve disc 120 could operate without delay when driven by the pneumatic unit 300. The groove could be, for example, at least one linear distribution structure, which could be parallel or perpendicular to a moving direction of the valve disc 120, or form an angle with the moving direction of the valve disc 120, the range of which could be between 0 and 180 degrees, to achieve a better vacuum breaking (or gas guiding) effect.

Taking the actuation correction structure 140 including the reset structure 150 as an example, the reset structure 150 is, for example, disposed on the linkage structure 160 used to connect the valve disc 120 and the pneumatic unit 300, so that the valve disc 120 has a reset capability. The reset structure 150 (or return-to-position structure) is configured to provide a restoring force when the valve disc 120 overtravels (i.e., exceeds a predetermined stroke range), thereby resetting the valve disc 120 to within the predetermined stroke range, which could prevent the valve disc 120 from sticking at a certain position of the valve body 110 due to overtravel or vacuum adsorption. For example, if the valve disc 120 moves beyond the originally predetermined fully open position P1 due to movement inertia, the reset structure 150 could accordingly provide a restoring force to the valve disc 120, so that the valve disc 120 could be reset to the fully open position P1 by this restoring force. A feature of the disclosure is that the restoring force provided by the reset structure 150 is generated by the overtravel phenomenon of the valve disc 120, so the magnitude of the restoring force corresponds to the overtravel distance of the valve disc 120. The longer the overtravel distance, the greater the force of the restoring force.

For example, the linkage structure 160 is a toggle linkage structure, and the reset structure 150 is disposed on the toggle linkage structure, thereby providing a symmetrical restoring force to the valve disc 120. In addition, the valve 100 may optionally further include a carriage 170 for carrying the valve disc 120. The toggle linkage structure includes a first link 162, a second link 164, and a rocker arm 166. Two ends of the first link 162 are pivotally connected to the carriage 170 and the second link 164. Two ends of the rocker arm 166 are pivotally connected to the second link 164 and a piston rod of the pneumatic unit 300, and the reset structure 150 is disposed on the second link 164. And one end of the rocker arm 166 is preferably pivotally connected to the middle section of the second link 164, and two ends of the second link 164 are preferably pivotally connected to one end of the first link 162 and the inner wall of the valve body 110. In addition, as mentioned above, the second link 164 may also optionally be provided with a baffle 165. The toggle linkage structure, by converting between a contracted state and an expanded state, could cause the carriage 170 and the valve disc 120 carried by it to move along a movement path. When the toggle linkage structure is in a contracted state, since the first link 162 and the second link 164 are in a crossed state, the baffle 165 could function to stop (or limit) the first link 162, preventing the first link 162 and the second link 164 from sticking to each other due to the aforementioned overtravel phenomenon.

In a preferred embodiment, the reset structure 150 could be one or a plurality of protruding structures, such as a hump shape, making the second link 164 a hump link. When there are two protruding structures, a symmetrical double-hump shape could be formed, which could provide symmetrical restoring force to the valve disc 120. The size of the plurality of protruding structures could be the same or different, and could be arranged at equal or unequal intervals, thereby providing customized and flexibly adjustable restoring force. In addition, the protruding structure and the linkage structure 160 could optionally be composed of the same material, or the protruding structure could optionally be integrally formed on the linkage structure 160 to enhance the overall structural strength.

The operating principle of the reset structure 150 lies in elastic deformation. When a component of the valve 100 (e.g., the valve disc 120 or the carriage 170) contacts the reset structure 150, the reset structure 150 will undergo an elastic deformation from an initial shape to accumulate the aforementioned restoring force. Thereby, the valve disc 120 could use the restoring force to leave the reset structure 150. When the valve disc 120 leaves the reset structure 150, the reset structure 150 will return to the aforementioned initial shape due to its own elasticity, thereby preparing for the next actuation.

In summary, the disclosure effectively solves the multiple problems existing in the prior art, such as vibration, micro-dust, vacuum adsorption, and inertial overtravel, through innovative control methods and valve structure design, thereby providing a valve and its control method with superior performance and high reliability.

In summary, the valve, its control method, and valve system of the disclosure may have one or more of the following advantages:

(1) The disclosure could regulate the vibration value generated by the valve when the valve disc operates through the pneumatic regulation procedure. For example, the disclosure could perform intelligent deceleration during the start and stop phases of valve disc operation, effectively suppressing impact vibration, and greatly avoiding dust such as contaminated particles caused by vibration, significantly improving product yield.

(2) The control method of the disclosure could incorporate a machine learning model, thereby automatically generating optimized pneumatic regulation modes for different valves. This intelligent feature enables the valve to have self-adjusting and highly customizable performance.

(3) The disclosure, through the actuation correction structure, could actively overcome physical limitations. The vacuum breaking structure could eliminate opening delays caused by vacuum adsorption, and the reset structure could effectively absorb inertial impact, ensuring precise valve disc reset, thereby improving the operational reliability of the valve and eliminating problems of sticking or inaccurate positioning.

Note that the specification relating to the above embodiments should be construed as exemplary rather than as limiting the present disclosure, with many variations and modifications being readily attainable by a person of average skill in the art without departing from the spirit or scope thereof as defined by the appended claims and their legal equivalents.

What is claimed is:

1. A control method for a valve, comprising the following steps:
providing a valve, the valve comprising a valve body and a valve disc, the valve body having a chamber, the valve disc being movably disposed in the chamber of the valve body and driven by a pneumatic unit to perform an operation; and
performing a pneumatic regulation procedure, the pneumatic regulation procedure adjusting a gas parameter supplied to the pneumatic unit in an adjustment mode when the valve disc performs the operation, so that the pneumatic unit pneumatically controls the operation of the valve disc accordingly, thereby regulating a vibration value generated by the valve when the valve disc performs the operation.

2. The method as claimed in claim 1, wherein the gas parameter is a gas pressure and/or a gas flow of at least one gas.

3. The method as claimed in claim 1, wherein the pneumatic regulation procedure adjusts the gas parameter supplied to the pneumatic unit, so that the operation of the valve disc becomes a smooth actuation, thereby reducing the vibration value generated by the valve when the valve disc performs the operation, wherein the smooth actuation is a smooth closing actuation, a smooth opening actuation, or a smooth moving actuation.

4. The method as claimed in claim 1, wherein the pneumatic regulation procedure adjusts the gas parameter supplied to the pneumatic unit by means of a solenoid valve, a piezoelectric pressure regulating valve, or a voice coil pressure regulating valve.

5. The method as claimed in claim 1, wherein the pneumatic regulation procedure further comprises establishing a machine learning model, the machine learning model defining a corresponding relationship among an adjustment value of the gas parameter, at least one valve characteristic value, and the vibration value, and determining the adjustment mode of the gas parameter supplied to the pneumatic unit according to the corresponding relationship defined by the machine learning model.

6. The method as claimed in claim 5, wherein the machine learning model is established by training using an artificial intelligence algorithm, wherein the valve characteristic value is selected from a group consisting of valve disc weight, valve disc stroke, air cylinder bore diameter, air path structure, and operating pressure.

7. The method as claimed in claim 5, wherein the pneumatic regulation procedure is fully automatic or partially automatic in adjusting the gas parameter supplied to the pneumatic unit.

8. The method as claimed in claim 1, wherein the adjustment mode of the pneumatic regulation procedure is a staged, progressive, or continuous adjustment of the gas parameter supplied to the pneumatic unit, so that the operation of the valve disc achieves a smooth actuation.

9. The method as claimed in claim 1, wherein the pneumatic regulation procedure adjusts the gas parameter supplied to the pneumatic unit using an open-loop control method or a closed-loop control method.

10. The method as claimed in claim 1, further comprising using at least one sensing element to sense at least one physical state of the valve, and the pneumatic regulation procedure adjusts the gas parameter supplied to the pneumatic unit in the adjustment mode in real-time according to the physical state of the valve, wherein the sensing element is selected from at least one or at least two of a group consisting of a pressure sensor, a force sensor, a temperature sensor, an optical sensor, an image sensor, a vibration sensor, an inertial sensor, and a current sensor.

11. The method as claimed in claim 1, wherein the valve is composed of a metal material, or a sealing surface of the valve is composed of the metal material.

12. A valve system, comprising:
a valve, the valve comprising a valve body and a valve disc, the valve body having a chamber, the valve disc being movably disposed in the chamber of the valve body;
a pneumatic unit configured to drive the valve disc of the valve to perform an operation; and
a control element, the control element adjusting a gas parameter supplied to the pneumatic unit in an adjustment mode according to the pneumatic regulation procedure as claimed in claim 1, so that the pneumatic unit pneumatically controls the operation of the valve disc accordingly, thereby regulating the vibration value generated by the valve when the valve disc performs the operation.

13. The valve system as claimed in claim 12, wherein the valve further comprises an actuation correction structure, for preventing the valve disc from incorrectly staying at a position in the valve body when the valve disc performs the operation.

14. The valve system as claimed in claim 13, wherein the actuation correction structure comprises one or both of a vacuum breaking structure and a reset structure selected from a group consisting thereof.

15. A valve, comprising:
a valve body, the valve body having a chamber;
a valve disc, the valve disc being movably disposed in the chamber of the valve body and driven by a pneumatic unit to perform an operation, wherein the pneumatic unit pneumatically controls the operation of the valve disc accordingly based on a gas parameter supplied to the pneumatic unit; and
an actuation correction structure configured to prevent the valve disc from incorrectly staying at a position in the valve body when the valve disc performs the operation.

16. The valve as claimed in claim 15, wherein the actuation correction structure comprises one or both of a vacuum breaking structure and a reset structure selected from a group consisting thereof.

17. The valve as claimed in claim 15, wherein the actuation correction structure comprises a vacuum breaking structure disposed on the valve body, the vacuum breaking structure breaking an adsorption phenomenon caused by the formation of a vacuum environment between the valve disc and the valve body, so as to prevent the valve disc from being adsorbed to the valve body.

18. The valve as claimed in claim 17, wherein the vacuum breaking structure is a groove, the groove being disposed on an inner surface of the valve body, for allowing an area of the valve body covered by the valve disc and another area of the valve body not covered by the valve disc to communicate during a period when the valve disc performs the operation.

19. The valve as claimed in claim 18, wherein the period during which the valve disc performs the operation is an opening actuation period, a closing actuation period, or a moving actuation period of the valve disc.

20. The valve as claimed in claim 18, wherein the valve disc comprises a plate body and an O-ring, the O-ring being disposed on the plate body, and during the period when the valve disc performs the operation, the O-ring partially overlaps the groove.

21. The valve as claimed in claim 18, wherein the groove is at least one linear distribution structure, and a distribution direction of the linear distribution structure is parallel or perpendicular to a moving direction of the valve disc, or the distribution direction of the linear distribution structure forms an angle with the moving direction, wherein the angle is between 0 and 180 degrees.

22. The valve as claimed in claim 15, wherein the actuation correction structure comprises a reset structure, the reset structure being disposed on a linkage structure for connecting the valve disc and the pneumatic unit, the reset structure being configured to provide a restoring force to the valve disc when the valve disc moves beyond a predetermined stroke range, so as to reset the valve disc to within the predetermined stroke range.

23. The valve as claimed in claim 22, wherein the reset structure is one or a plurality of protruding structures.

24. The valve as claimed in claim 23, wherein the one or the plurality of protruding structures are hump-shaped.

25. The valve as claimed in claim 23, wherein the plurality of protruding structures are of the same or different sizes, or the plurality of protruding structures are arranged at equal or unequal intervals.

26. The valve as claimed in claim 23, wherein the one or the plurality of protruding structures are integrally formed on the linkage structure, or the one or more protruding structures and the linkage structure are composed of the same material.

27. The valve as claimed in claim 22, wherein when a component of the valve contacts the reset structure, the reset structure undergoes an elastic deformation from an initial shape to accumulate the restoring force, thereby enabling the valve disc to leave the reset structure by means of the restoring force, and when the valve disc leaves the reset structure, the reset structure returns to the initial shape.

28. The valve as claimed in claim 27, wherein the valve further comprises a carriage for carrying the valve disc, the linkage structure is a toggle linkage structure, and the reset structure is disposed on the toggle linkage structure.

29. The valve as claimed in claim 28, wherein the toggle linkage structure comprises a first link, a second link, and a rocker arm, two ends of the first link are pivotally connected to the carriage and the second link, two ends of the rocker arm are pivotally connected to the second link and a piston rod of the pneumatic unit, and the reset structure is disposed on the second link.

30. The valve as claimed in claim 29, wherein the toggle linkage structure further comprises a baffle disposed on the second link, for stopping the first link when the toggle linkage structure changes from an expanded state to a contracted state.
